(19) United States
(12) Patent Application Publication
(10) Pub. No.: US 2013/0166334 A1
(43) Pub. Date: Jun. 27, 2013

(54) ELECTRONIC MENU AND ORDERING SYSTEM

(71) Applicants: Michael A. Liberty, Windermere, FL (US); Jeffrey Ian Pollack, Manhattan Beach, CA (US)

(72) Inventors: Michael A. Liberty, Windermere, FL (US); Jeffrey Ian Pollack, Manhattan Beach, CA (US)

(21) Appl. No.: 13/722,913

(22) Filed: Dec. 20, 2012

Related U.S. Application Data
(60) Provisional application No. 61/578,815, filed on Dec. 21, 2011.

(51) Int. Cl. G06Q 10/02

(52) U.S. Cl. CPC G06Q 10/02
USPC 705/5; 705/26.61

(57) ABSTRACT

Embodiments are directed to providing meal information and event ticketing to a customer via an electronic menu. In one scenario, a computer system provides an electronic menu to a user. The electronic menu includes a user interface that allows users to select different meals provided by a restaurant to obtain information about the meal. The electronic menu further provides an indication of local events that are to take place within a specified time period and within a specified distance from the restaurant. The computer system receives an input from the user selecting at least one of the meals provided by the electronic menu's user interface and, in response to receiving the input, provides meal-related information for the user-selected meal. The meal-related information includes textual information, audio information, pictures and/or video content.

### CROSS-REFERENCE TO RELATED APPLICATIONS

This application claims priority to, and the benefit of, Provisional Patent Application No. 61/578,815, entitled “Electronic Menu and Ordering System”, filed on Dec. 21, 2011, which is incorporated by reference in its entirety herein.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to interact with other software applications or other computer systems. For example, internet browsers or other applications may be designed to allow communication between the user's computing device and a remote computer. As such, these applications may provide access to a wide range of information and services provided by the internet or “the cloud”. These services may allow application users to interact with each other through personal or public message systems. Such applications are often referred to as social media applications or services.

### BRIEF SUMMARY

Embodiments described herein are directed to providing meal information and event ticketing to a customer via an electronic menu. In one embodiment, a computer system provides an electronic menu to a user. The electronic menu includes a user interface that allows users to select different meals provided by a restaurant to obtain information about the meal. The electronic menu further provides an indication of local events that are to take place within a specified time period and within a specified distance from the restaurant. The computer system receives an input from the user selecting at least one of the meals provided by the electronic menu's user interface and, in response to receiving the input, provides meal-related information for the user-selected meal. The meal-related information includes textual information, audio information, pictures and/or video content.

In another embodiment, a computer system provides an electronic menu, receives meal-selection input and provides meal-related information, as above. The computer system further receives a second input from the user selecting at least one of the local events provided in the electronic menu, where the selected local event begins at a specified time. The computer system provides an interface that allows the user to purchase tickets to the selected local event through the electronic menu. The computer system may further determine the starting time for the selected local event, determine an anticipated finish time for the user by which the user will be finished dining and, based on the determined anticipated finish time, provide an indication to the user that the user will have their meal served in time to make the selected local event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an electronic menu interface displayed on a tablet computer system.

FIG. 2 illustrates a restaurant customer's personal profile including associated content.

FIG. 3 illustrates a computing environment in which an electronic menu application can interact with both internal and external computing systems.

FIG. 4 illustrates an alternative example electronic menu interface in which a restaurant customer can purchase tickets to local events.

FIG. 5 illustrates an example flowchart for providing meal information to a customer via an electronic menu.

### DETAILED DESCRIPTION

Embodiments described herein are directed to providing meal information and event ticketing to a customer via an electronic menu. In one embodiment, a computer system provides an electronic menu to a user. The electronic menu includes a user interface that allows users to select different meals provided by a restaurant to obtain information about the meal. The electronic menu further provides an indication of local events that are to take place within a specified time period and within a specified distance from the restaurant. The computer system receives an input from the user selecting at least one of the meals provided by the electronic menu's user interface and, in response to receiving the input, provides meal-related information for the user-selected meal. The meal-related information includes textual information, audio information, pictures and/or video content.

In another embodiment, a computer system provides an electronic menu, receives meal-selection input and provides meal-related information, as above. The computer system further receives a second input from the user selecting at least one of the local events provided in the electronic menu, where the selected local event begins at a specified time. The computer system provides an interface that allows the user to purchase tickets to the selected local event through the electronic menu. The computer system may further determine the starting time for the selected local event, determine an anticipated finish time for the user by which the user will be finished dining and, based on the determined anticipated finish time, provide an indication to the user that the user will have their meal served in time to make the selected local event.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

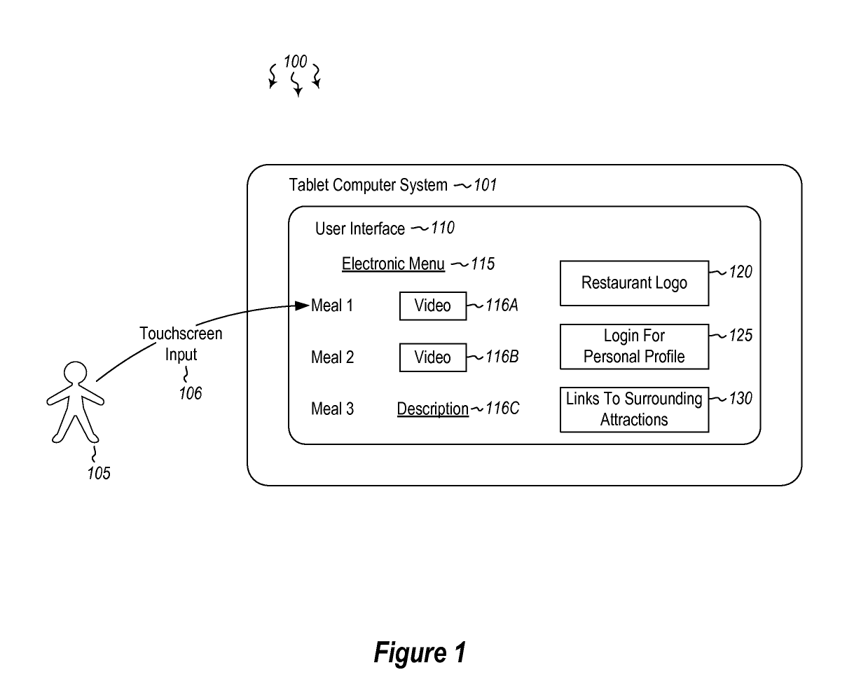

FIG. 1 illustrates a computer architecture 100 in which the principles of the present invention may be employed. Computer architecture 100 includes computer system 101. Computer system 101 may be any type of local or distributed computer system, including a cloud computing system. In some cases, the computer system is a tablet computer system or a smart phone. The computer system 101 may be connected to one or more local or remote data stores, including the internet (or “the cloud”). The computer system may be configured to run applications, including applications that communicate with cloud servers. These cloud servers may provide information, applications, profile management, user login and other services, as well as any other type of information management.

An “electronic menu” or “electronic menu system” refers to a tablet- (or other computer system) based electronic menu, ordering system, and commerce referral portal that provides restaurant customers information, value opportunities, and infotainment. These services may enhance the users' dining experience at a restaurant as well as at home. The electronic menu system may also provide restaurant owners with valuable data about their customers. The electronic menu system, through various applications and architectures described herein, allows restaurant customers access to video databases and video streams showing them views of how the food they are thinking about ordering is prepared, along with the meal's ingredients, nutritional information and other information. If the customer enjoys the meal that he or she has just eaten, the customer may use The electronic menu system to instantly email the recipe and video links to their personal mailbox, allowing them to recreate their meal at home. That customer may then also have an opportunity to participate in a interest-based dynamic social network that revolves around meal creation, whether dining in or out.

As shown in environment 100 of FIG. 1, the electronic menu may be presented to the user via tablet computer system 101. The tablet computer system includes a user interface 110 that shows an electronic menu 115. The user (or customer, used interchangeably herein) 105 may then interact with the electronic menu via the tablet's touchscreen interface (e.g. using touchscreen input 106). The electronic menu 115 is displayable on a computer, tablet, smart phone or any other computing device capable of running applications and/or displaying data.

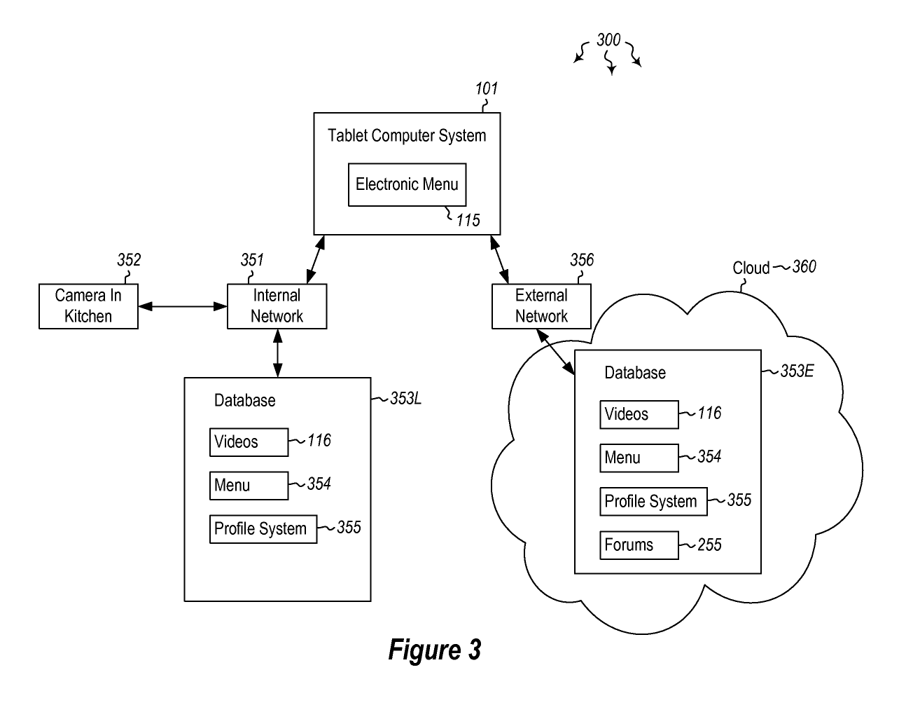

Environment 300 of FIG. 3 illustrates that computer system 101 may interact with various items over wired or wireless data connections. For instance, the computer system may interact with a local database 353L via a network that is internal 351 to the restaurant. Additionally or alternatively, the computer system may interact with one or more computer systems or external databases 353E in the cloud 360 (or the internet). The internal network 351 may provide access to various devices including a camera in the kitchen 352 that shows the chef preparing the customer's meal. The internal network also provides access to a database 353L with videos 116, electronic menu items 354 and/or a profile system 355 (which will be explained in greater detail below). The external network 356 may similarly provide access to a database 353E with videos, menu items, forum access 255 and a profile system. The videos, menu and other items may be provided solely by the internal network, solely by the external network, or by a combination of the two. As such, any data or other item not stored on the computer system 101 may be accessed via either the internal network or the external network.

In some embodiments, it may be assumed that the electronic menu is displayed on a tablet computer system. In some cases, a restaurant owner may provide one (or more) of these tablets at each table in their restaurant for use by customers. The electronic menu (or “electronic tablet menu” in such embodiments) may be geared to specifically reflect the look, feel, and overall aesthetic of the restaurant. For instance, an electronic tablet menu may include the restaurant's colors, font, logo 120, trademarks, trade dress and other items that present the overall look and feel of a restaurant. A customer may interact with the electronic menu 115 by touching a particular menu item. The selected menu item may have various types of information linked to it, including video information, audio, pictorial and/or textual information. Other entertainment videos, games or other items may be added to the electronic menu to inform the user about the restaurant and/or their meal and/or surrounding attractions (including links 130) while they make their decision.

In embodiments herein, the videos (e.g. 116A, 116B) may include pre-recorded or live video presentations of the meal being made. The customer may thus be able to see each of the ingredients that are put into the meal. This may be beneficial for those with allergies, gluten problems, or other food-related issues. Moreover, the customer may be able to see how the items are combined, how they are cooked, and how they are plated. The video may be accompanied by food information such as the amount of calories in the meal (and/or each individual ingredient), the amount of preservatives or salt content or any other nutritional information the restaurant owner wishes to provide. Still further, many other types of background information may be provided about the history of the dish, cultures where the dish is popular, books about that meal or culture, cookbooks for that type of food, or any other type of information related to cooking, preparing or presenting the meal.

The electronic menu may also provide access to message boards (e.g. forums 255) commenting on how others enjoyed that meal (i.e. meal ratings), as well as access to a live survey of other customers in the restaurant that may have just enjoyed that particular choice in that restaurant on that same day. The recommendations may also, at least in some cases, recommend another meal instead. The electronic menu 115 may also provide access to a shopping list for each meal, so that the customer can buy the ingredients used to cook the meal they selected. The electronic menu system, in effect, removes barriers between restaurant cuisine and home-cooked meals by tearing away the secrecy of recipes and methods of professional chefs. As such, users at home can prepare the meal themselves by following the instructions on the related video if they wish to do so.

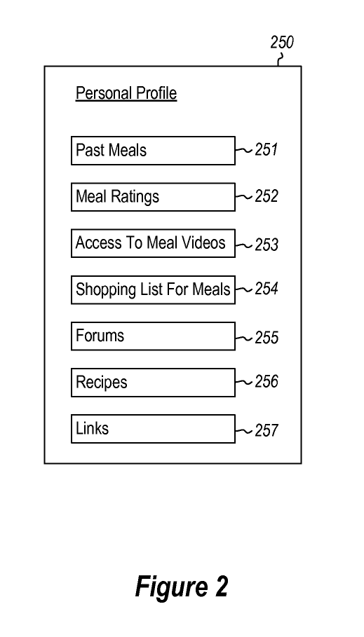

In some embodiments, the electronic menu may provide a way for a customer to enter their email address (or other login information) to log in (e.g. via button 125) to their personal profile via profile system 355. For example, as shown in FIG. 2, each customer may have their own personal profile 250 that includes the videos 253 and recipes 256 for the meals they have previously eaten (251). The customer may use the electronic menu 115 to attach the meal to the user's profile, along with any videos (116A, 116B and/or accompanying description 116C). The user can then access their profile via the internet 360 from anywhere and view recipes and other information about the meal they selected.

In addition to the recipe, the profile information may also include other information such as a grocery list 254, links 257 to websites offering similar meal recipes, links to local grocery stores (and potentially coupons for those items), or any other type of associated information. In some cases, where a user is registering for the first time, any or all of the above information may be sent to the user via an email. The email may further include links to set up a profile 250 that may be used in multiple different restaurants. The user's profile may further include food ratings 252, special dishes the user likes, preferences for certain restaurants, or other items. In some cases, the account may be accessible to the user via a personal identification number (PIN), enterable through the electronic menu. Once at home, the user may log in to their account or profile and view the recipe and other related information 251. Additionally or alternatively, the recipe may be viewed while the user is in the restaurant to inform the user about the contents of a particular dish.

Each recipe that is sent to a user (or is attached to the user's profile) may include an indication (whether via video, audio, pictures and/or text) of how the meal was made in the restaurant. Step-by-step instructions may be included to show how to scale the ingredients, prepare certain foods (such as meat) and other methodologies used by the chef to create the meal. Instructions may also be provided on how to expand the dish, alter the dish or cook the dish for various size groups (including groups of 1 as well as large groups). In addition, low sodium, low fat, no-egg or other ingredient substitutes eating options may also be included for use by the user.

As mentioned previously, videos 116A/116B may be provided on the electronic menu 115. These videos may be stored on the tablet or other computer system, or may be streamed from a local source (e.g. local database 353L) or a remote source (e.g. external database 353E on cloud 360). The videos may include in-the-kitchen meal preparation cooking tips by the chefs who created the meals. The videos may also include footage of trips to local food markets or grocery stores showing how and where to select all the items for that meal. For instance, tips may be provided indicating how to select a certain vegetable or how to determine its ripeness. In one example, a customer may select Yellowtail Carpaccio at their favorite restaurant. The user may then be able to see, via the electronic menu, where and how that chef chooses the fish. The user may then see how the fish is brought back to the kitchen, sliced, cooked and prepared. The video may also show how the chef prepares the meal's plating (e.g. via kitchen camera 352).

As a customer uses the electronic menu system, over time, the customer will begin to amass a collection of recipes 256 from multiple different participating restaurants. The electronic menu system's access to cloud databases 353E and information management allow the customer to search his or her personal recipes by any number of filters. For example, the user may choose search filters ranging from calories to type of fish to grams of protein to type of curry to whatever the user may want. Each recipe that is accessed from the electronic menu system may have message boards 255 and other interactive social network communication tools that allow customers to learn from others. For instance, a user may learn new ways to create the dish they received at the restaurant, at home. These forums may also show ratings for meals at different restaurants, as well as ratings indicating how hard or easy the meal is to prepare at home.

Embodiments of the electronic menu system may be integrated with multiple different social media websites including Facebook® and Twitter®. Smartphone applications may also be used to provide access to the users' recipes whenever and wherever the user is. In addition to providing customers the information of how to make the restaurant meal at home, the electronic menu system may also provide suggestions as to where that customer might find some of those ingredients they need to prepare the meal so that it tastes just like it did at the restaurant. When a customer chooses to send a recipe home (either via email or by attaching the recipe to their personal profile 250) the user may agree to receive notifications of special offers or coupons from that restaurant or from other merchants. Participating users may pay a membership fee that gives them, based upon membership type, anywhere from a limited number to an unlimited amount of recipes, as well as additional data stored in their account in their cloud.

Moreover, the electronic menu system may help restaurants develop and offer to their customers food and entertainment choices specifically catered to those users. In some cases, the electronic menu system may provide event opportunities ranging from discount pricing to invited tastings of new menu items for specific users. As such, the electronic menu 115 may provide many types of information related to the meals it provides. It also provides ways to interact with other users, store recipes and videos for well-liked meals, and allow users to see how their food is prepared.

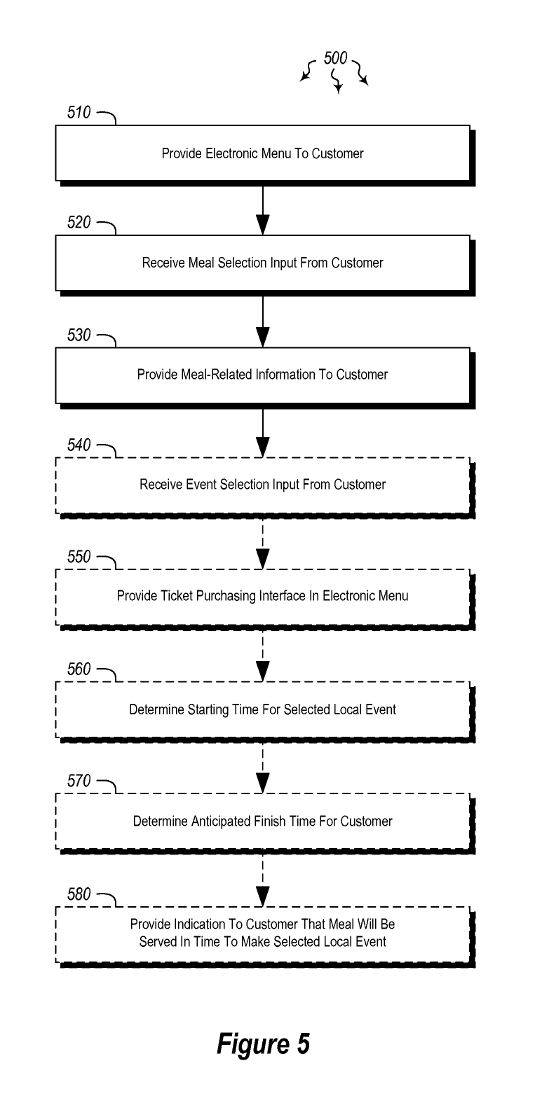

In view of the systems and architectures described above, methodologies that may be implemented in accordance with the disclosed subject matter will be better appreciated with reference to the flow chart of FIG. 5 below. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

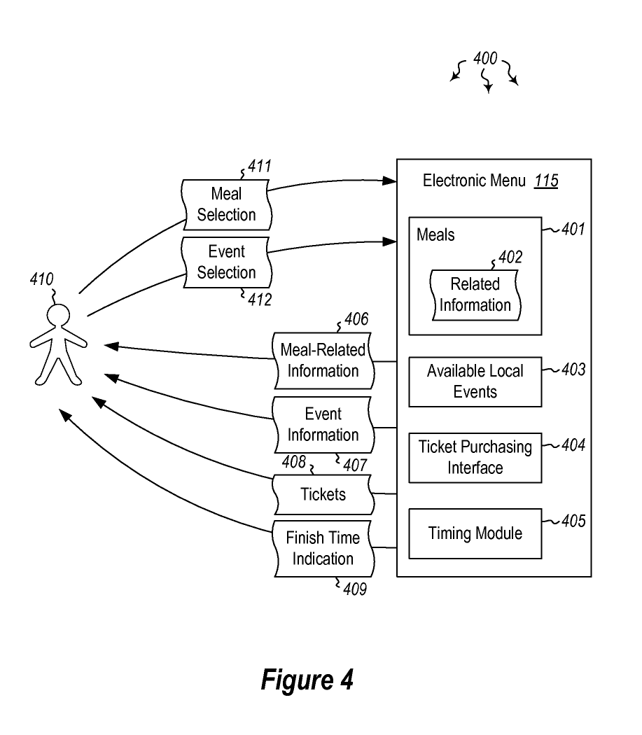

FIG. 5 illustrates a flowchart of a method 500 for providing meal information and event ticketing to a customer via an electronic menu. The method 500 will now be described with frequent reference to the components and data of environment 400 of FIG. 4.

Method 500 includes an act of providing an electronic menu to a user, the electronic menu comprising a user interface that allows users to select different meals provided by a restaurant to obtain information about the meal, the electronic menu further providing an indication of one or more local events that are to take place within a specified time period and within a specified distance from the restaurant (act 510). The electronic menu 115 may be provided on a tablet computing system, smart phone, laptop or any other type of computing system. In some cases, the electronic menu may be provided as a downloadable application for the tablet or other computing system. The electronic menu includes one or more different meals 401 with related information 402. Examples of this related information will be described further below.

Method 500 also includes an act of receiving a first input from the user selecting at least one of the meals provided by the electronic menu's user interface (act 520). For example, user (i.e. customer) 410 may send an indication 411 of the meal they have selected. In response to receiving user 410's first input 411, the electronic menu provides meal-related information 406 for the user-selected meal. The meal-related information may include textual information, audio information, pictures and/or video content (act 530).

The meal-related information 406 may further include meal ratings for one or more of the restaurant's meals. The ratings may be taken from external websites, or may be taken from internal surveys or comments provided by other customers. In some cases, the meal ratings may be shown next to the meal in the electronic menu 115. The meal ratings may include ratings for the current day and/or past ratings. The electronic menu may further provide access to meal recommendations from other restaurant customers that have previously dined (or are currently dining) at the restaurant.

The electronic menu may further provide access to recipe information for the selected meal. The recipe may include each of the ingredients used to make the meal and their corresponding quantities. The recipe may further include preparation instructions including text, pictures and/or video content. The electronic menu may also provide access to nutritional information for the selected meal. The nutritional information may be displayed next to the selected meal, as a pop-up shown on top of the meal, or in some other user-appealing manner. The electronic menu may still further provide access to a shopping list for the selected meal's ingredients. The user may use this shopping list to shop online for the ingredients needed to make the selected meal. Additionally or alternatively, the shopping list may be printed, sent to the user's smart phone, sent to the user's email address (e.g. using the profile information 250), or otherwise transferred to the user. The shopping list may also include a list of nearby stores that carry the items needed to prepare the selected meal.

The electronic menu may yet further provide access to media associated with the selected meal including written reviews, audio reviews, video reviews or other types of media. In some cases, the media associated with the selected meal may include a video showing how the meal is prepared. Additionally or alternatively, the media associated with the selected meal may include pictures and/or corresponding text illustrating the ingredients of the selected meal and illustrating how the meal is prepared. The electronic menu may also provide access to one or more web links to internet resources related to the selected meal. The additional information may be dynamically downloaded from a remote network data store (e.g. database 353E of FIG. 3). As mentioned above with regard to FIG. 2, the electronic menu may allow users to log in and access their personal profile which includes the user's meal preferences, dietary constraints and other user settings. . The user profiles may also provide the user access to meal information, internal and external forums, and associate media. It may also provide access to one or more external internet forums associated with one or more aspects of the selected meal (including ingredients, preparation, time-saving ideas, etc.

Method 500 includes an optional act of receiving a second input from the user selecting at least one of the local events, the selected local event beginning at a specified time (act 540). The second input may be an event selection 412, selecting an event from the available local events 403. The electronic menu 115 may display event information 407 for a variety of different local events including plays, musicals, concerts, movies, sporting and other types of events. The menu 115 may provide a ticketing interface 404 that allows the user to purchase tickets 408 to the selected local event through the electronic menu (act 550). In some cases, the tickets are for events that are occurring later that day. In other cases, the tickets are for events that are further in the future.

Method 500 includes an optional act of determining the starting time for the selected local event (act 560). The electronic menu 115 may access information from the internet or another source to determine starting times for the available local events 403. The timing module 405 may determine an anticipated finish time for the user by which the user will be finished dining (act 570) and, based on the determined anticipated finish time, may provide an indication to the user that the user will have their meal served in time to make the selected local event (act 580). Thus, in one example, user 410 may sit down to eat and be presented with a list of those shows, concerts, movies, sporting or other events that have not yet started, and which the user would likely be able to make. The timing module may determine, based on when the user sat down at the table, a likely time by which the user will be finished dining 409. This time may be taken from average dining times for that restaurant and/or for a given group size.

In some embodiments, the available local events 403 may be filtered by which events the user would be able to make, based on the time the user sat down to eat or based on some other time such as when the user ordered their meal. Tickets may be purchased by the user for those local events that start after the determined finish time 409 and are within a specified travel time window. Accordingly, the available events 403 may also take into account travel time from the restaurant, and may also include a buffer time of 30-60 minutes (or more) to compensate for restaurant and/or travel delays. The travel time window includes event locations which can be traveled to within a specified amount of time. In some cases, the electronic menu 115 may provide a list of events that the user is (virtually) guaranteed to make, as they start sufficiently far in the future that the restaurant can be sure that the user will have finished dining in time to make the event.

Accordingly, the electronic menu 115 may provide not only a way to order a meal at a restaurant, but may also provide information about the meal including nutrition information, reviews and preparation instructions. The electronic menu may be further configured to provide a ticket purchasing interface 404 that allows users to purchase tickets to surrounding events. The electronic menu may be configured to only show those events that the customer could reasonably make. As such, the electronic menu can provide a full-featured experience for restaurant diners.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for providing meal information to a customer via an electronic menu, the method comprising:
an act of providing an electronic menu to a user, the electronic menu comprising a user interface that allows users to select different meals provided by a restaurant to obtain information about the meal, the electronic menu further providing an indication of one or more local events that are to take place within a specified time period and within a specified distance from the restaurant;
an act of receiving a first input from the user selecting at least one of the meals provided by the electronic menu's user interface; and
in response to receiving the user's first input, an act of providing one or more portions of meal-related information for the user-selected meal, the meal-related information comprising at least one of the following: textual information, audio information, pictures and video content.

2. The method of claim 1, further comprising:
an act of receiving a second input from the user selecting at least one of the local events, the selected local event beginning at a specified time; and
an act of providing an interface that allows the user to purchase one or more tickets to the selected local event through the electronic menu.

3. The method of claim 2, further comprising:
an act of determining the starting time for the selected local event;
an act of determining an anticipated finish time for the user by which the user will be finished dining; and
based on the determined anticipated finish time, an act of providing an indication to the user that the user will have their meal served in time to make the selected local event.

4. The method of claim 2, wherein tickets are purchasable by the user for those local events that start after the determined finish time.

5. The method of claim 4, wherein tickets are purchasable by the user for those local events that start after the determined finish time and are within a specified travel time window.

6. The method of claim 5, wherein the travel time window comprises one or more event locations which can be traveled to within a specified amount of time.

7. The method of claim 1, wherein the electronic menu provides access to one or more external internet forums associated with one or more aspects of the selected meal.

8. The method of claim 1, wherein the electronic menu provides access to meal ratings for one or more of the restaurant's meals.

9. The method of claim 1, wherein the electronic menu provides access to meal recommendations from other restaurant customers.

10. The method of claim 1, wherein the electronic menu provides access to recipe information for the selected meal.

11. The method of claim 1, wherein the electronic menu provides access to nutritional information for the selected meal.

12. The method of claim 1, wherein the electronic menu provides access to a shopping list for the selected meal's ingredients.

13. A computer system comprising the following:
one or more processors;
system memory;
one or more computer-readable storage media having stored thereon computer-executable instructions that, when executed by the one or more processors, causes the computing system to perform a method for providing meal information and event ticketing to a customer via an electronic menu, the method comprising the following:
an act of providing an electronic menu to a user, the electronic menu comprising a user interface that allows users to select different meals provided by a restaurant to obtain information about the meal, the electronic menu further providing an indication of one or more local events that are to take place within a specified time period and within a specified distance from the restaurant;
an act of receiving a first input from the user selecting at least one of the meals provided by the electronic menu's user interface;
in response to receiving the user's first input, an act of providing one or more portions of meal-related information for the user-selected meal, the meal-related information comprising at least one of the following: textual information, audio information, pictures and video content
an act of receiving a second input from the user selecting at least one of the local events, the selected local event beginning at a specified time; and
an act of providing an interface that allows the user to purchase one or more tickets to the selected local event through the electronic menu.

14. The computer system of claim 13, wherein the electronic menu provides access to one or more portions of media associated with the selected meal.

15. The computer system of claim 14, wherein at least one of the portions of media associated with the selected meal comprises a video showing how the meal is prepared.

16. The computer system of claim 14, wherein at least one of the portions of media associated with the selected meal comprises one or more pictures and corresponding text illustrating the ingredients of the selected meal and illustrating how the meal is prepared.

17. The computer system of claim 13, wherein the electronic menu provides access one or more web links to internet resources related to the selected meal.

18. The computer system of claim 13, wherein the additional information is dynamically downloaded from a remote network data store.

19. The computer system of claim 13, wherein the electronic menu allows users to log in and access their personal profile, the personal profile including at least one of the following: the user's meal preferences, dietary constraints and other user settings.

20. A computer system comprising the following:
one or more processors;
system memory;
one or more computer-readable storage media having stored thereon computer-executable instructions that, when executed by the one or more processors, causes the computing system to perform a method for providing meal information and event ticketing to a customer via an electronic menu, the method comprising the following:
an act of providing an electronic menu to a user, the electronic menu comprising a user interface that allows users to select different meals provided by a restaurant to obtain information about the meal, the electronic menu further providing an indication of one or more local events that are to take place within a specified time period and within a specified distance from the restaurant;
an act of receiving a first input from the user selecting at least one of the meals provided by the electronic menu's user interface;
in response to receiving the user's first input, an act of providing one or more portions of meal-related information for the user-selected meal, the meal-related information comprising at least one of the following: textual information, audio information, pictures and video content;
an act of receiving a second input from the user selecting at least one of the local events, the selected local event beginning at a specified time;
an act of providing an interface that allows the user to purchase one or more tickets to the selected local event through the electronic menu;
an act of determining the starting time for the selected local event;
an act of determining an anticipated finish time for the user by which the user will be finished dining; and
based on the determined anticipated finish time, an act of providing an indication to the user that the user will have their meal served in time to make the selected local event.
